(19) United States
(12) Patent Application Publication
(10) Pub. No.: US 2007/0202267 A1
(43) Pub. Date: Aug. 30, 2007

(54) Sizing compositions for glass and polyolefin surfaces and methods of use

(76) Inventor: Emil Martin, Atlanta, GA (US)

Correspondence Address: WELSH & FLAXMAN LLC, 2000 DUKE STREET, SUITE 100, ALEXANDRIA, VA, 22314, US

(21) Appl. No.: 11/709,683

(22) Filed: Feb. 23, 2007

Related U.S. Application Data
(60) Provisional application No. 60/776,209, filed on Feb. 24, 2006.

(51) Int. Cl. B05D 7/00

(52) U.S. Cl. 427/407.2

(57) ABSTRACT

A sizing compound and method used in forming a surface conditioner, primer, tie coat and/or wash coat for surfaces or substrates made of glass, ceramic material, or a polyolefin or substituted polyolefins such as polyethylene, polyethylene terephthalate and polyethylene nitrile. The sizing compound contains a mixture of a coupling agent comprising at least one organosilicon compound and a bonding agent, namely, fluorine and is used to improve the adherence of polymer coatings and inks to the surface of the glass, ceramic material, and polyolefin substrates. The sizing compound will adhere to the above named surfaces to improve adhesion to both porous and non-porous surfaces. The sizing compound can be applied by spray, vapor, brush, dipping, cascading or mopping. When dry the sizing coating on the substrate produces a bond between the substrate and the polymeric coating or ink applied thereon. The sizing compound is primarily designed to receive ultraviolet (UV), electron beam (EB) and radiant heat cured coatings or inks.

### BACKGROUND OF THE INVENTION

1. Field of the Invention

The present invention relates to a process for the conditioning treatment of surfaces of glass, ceramics, or polyolefins to improve the adhesion of decorative coatings, primarily ultraviolet, electron beam and radiant heat curable polymer coatings and inks, to the surfaces and to the sizing compositions used as surface conditioning agents.

2. Discussion of the Background

Commercial ceramic and glassware is often decorated by applying a pattern in colored ink on the surface of the substrate with screen printing, offset printing, or any other direct application technique. The glass is then baked at high temperatures to bond the design or indicia to the glass surface. This process, sometimes referred to as applied ceramic labeling (ACL), exhibits certain drawbacks. Often, the ink compositions contain heavy metals and volatile organic solvents (VOC's). Both VOC's and heavy metals are undesirable from the environmental point of view. Second, ACL requires high temperature ovens for the baking step, resulting in considerable energy usage and an increased potential for worker injury due to the high temperatures of the operation process. Furthermore, high temperature ovens are expensive, cumbersome pieces of equipment requiring considerable floor space in factories.

The decoration of glass and ceramic ware with ultraviolet (UV) radiation curable organic pigmented inks is well known in the art. Organic inks generally can be cured by exposure to radiation, such as ultraviolet radiation, thus obviating the need for high temperature baking. In addition, UV curable organic inks can be formulated to contain little or no VOC's or other nonaqueous solvents. Organic inks generally exhibit excellent adherence to glass.

In many countries, it is mandatory that beverages such as beer and soda, be marketed in returnable glass bottles. After the beverage has been consumed, the glass bottles are returned to the beverage filler. They are then cleaned, sterilized, refilled, relabeled, and resold. Decals and paper labels are most often used to decorate returnable beverage bottles. Both types of labels have many drawbacks. For example, both paper labels and decals are expensive. In addition, labels and decals can easily come off upon exposure to water or other materials. In addition, many of the adhesives used in decals become sticky when subjected to the bottle cleaning process, and cause machines, drains, and associated process equipment to become gummed up and malfunction.

There is a need for a method to decorate returnable beverage bottles that provides excellent decorative effect. In addition, the method must be cost competitive when compared to paper labels and decals. At the same time it is preferable that the decorative indicia applied should be easily strippable from the glass container between fillings.

Different solutions making it possible to improve the adhesion of polymers to glass have been described in the prior art. For example, U.S. Pat. No. 6,136,382, to Kamen et al., proposes the use of silane coupling agents in an aqueous solution as primer compositions for improving the adhesion of radiation curable ink onto glass surfaces. The problem encountered by many of these solutions is that glass-polymer adhesion is not obtained in a satisfactory manner.

Furthermore, manufacturers employing printing techniques on surfaces such as polyethylene terephthalate have been unable to find a suitable coating which will adhere to PET and provide co-adhesion for subsequent application of decorative coatings.

### SUMMARY OF THE INVENTION

A process for preparing a vitreous or glass surface for adhesion to a polymer film or ink including depositing a sizing compound of an aqueous mixture of a coupling agent and fluorine on the vitreous or glass surface to form a sizing layer.

The invention is directed to a method for decorating a substrate in the form of a vitreous or polyolefin article comprising the steps of:
a) coating the substrate with a sizing composition comprising a mixture of a reducing agent and fluorine in solution to form a sizing layer,
b) applying a predetermined design of an ultraviolet (UV), electron beam (EB) or a radiant heat cured coating or ink composition over the sizing layer, and
c) curing the ink on the substrate in an appropriate manner thereby bonding the coating to the substrate via the sizing layer.

Accordingly, one object of the present invention is to provide a process for the treatment of glass, ceramic, or polyolefin surfaces in order to improve the adhesion of ultraviolet, electron beam and radiant heat curable polymer coatings and inks or other decorative coatings to the surfaces.

A further object of the present invention is to provide a process for treating surfaces of a variety of types of glass, such as soda-lime, borosilicate and opal glass, and of ceramics to improve the adhesion of coatings, polymers and inks, especially ultraviolet, electron beam and radiant heat curable polymer coatings and inks to the glass or ceramic surfaces.

A further object of the present invention is to provide a process for treating the surfaces of a variety of polyolefin compositions, including polyethylene, polyethylene terephthalate and polyethylene nitrile to improve the adhesion of coatings, polymers and inks, especially ultraviolet, electron beam and radiant heat curable polymer coatings and inks, to the polyolefins.

A further object of the present invention is to provide a glass object, preferably a hollow glass container such as a bottle, having a durable, abrasion resistant, but optionally removable coating including ornate printed designs or wording without the need for long curing times.

A further object of the present invention is to provide a surface conditioner, primer, tie coat and/or wash coat for surfaces or substrates made of glass, ceramic material, or a polyolefin formulated in such a manner as to form a bond between the substrates and the coatings or inks.

These and other objects of the present invention will be apparent in view of the following detailed description of the invention.

### DETAILED DESCRIPTION OF THE PREFERRED EMBODIMENTS

The present invention relates to a sizing composition and to a process using such sizing compositions as surface conditioners, primers, tie coats and/or wash coats for surfaces or substrates made of glass, ceramic material, or a polyolefin, such as polyethylene, including substituted polyolefins such as polyethylene terephthalate (PET) and polyethylene nitrile (PEN). In particular the process of the present invention is particularly useful in improving the adherence of ultraviolet (UV), electron beam (EB) or heat radiation curable polymer coatings and inks onto such substrates, particularly hollow objects, such as jars, cups, bottles, flasks, etc. in order to permit the adhesion of a polymer or an ink to the surface of the substrate, preferably a vitreous substrate such as glass.

The present invention employs the use of a sizing composition containing a non-aqueous or an aqueous solvent-based solution of a coupling agent selected from the group of organosilanes, organosiloxanes and mixtures thereof together with a bonding agent such as fluorine. It is preferable that a surfactant such as an alkali metal silicate including sodium or potassium silicate be admixed with the sizing composition. Water based solvents used in the preparation of the present invention should be free of contaminants that could negatively affect the pot life and performance of the sizing coating. Therefore, it is desirable to use deionized or distilled water.

Suitable examples of the organosilane and/or siloxane for use in the present invention include but are not limited to: tetra-alkoxysilanes including tetramethoxysilane, tetraethoxysilane, tetra-n-propoxysilane, tetra-i-propoxysilane, and tetra-n-butoxysilane; trialkoxysilane including methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, n-butyltrimethoxysilane, n-butyltriethoxysilane, n-pentyltrimethoxysilane, n-hexyltrimethoxysilane, n-heptyltrimethoxysilane, n-octyltrimethoxysilane, vinyltrimethoxysilane, vinyltriethoxysilane, cyclohexyltrimethoxysilane, cyclohexyltriethoxysilane, phenyltrimethoxysilane, phenyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyl-trimethoxysilane, 3-aminopropyltriethoxysilane, 2-hydroxyethyl-trimethoxysilane, 2-hydroxyethyl-triethoxysilane, 2-hydroxypropyltrimethoxysilane, 2-hydroxypropyltriethoxysilane, 3-hydroxypropyl-trimethoxysilane, 3-hydroxypropyltriethoxysilane, 3-mercaptopropyltrimethoxysilane, 3-mercaptopropyl-triethoxysilane, 3-isocianatopropyltrimethoxysilane, 3-isocianatopropyltriethoxysilane, 3-glycidoxypropyl-trimethoxysilane, 3-glycidoxypropyltriethoxysilane, 2-(3,4-epoxycyclohexyl)ethyltrimethoxysilane, 2-(3,4-epoxycyclohexyl) ethyltriethoxysilane, 3-(meth)-acryloxypropyltrimethoxysilane, 3-(meth)acryloxypropyl-triethoxysilane, 3-ureidopropyltrimethoxysilane, 3-ureidopropyltriethoxysilane, nonafluorohexyl-trimethoxysilane, heptadecafluorodecyltrimethoxysilane, and tridecafluoroctyltrimethoxysilane; dialkoxysilanes including dimethyldimethoxysilane, dimethyldiethoxysilane, diethyldimethoxysilane, diethyldiethoxysilane, di-n-propyldimethoxysilane, di-n-propyldiethoxysilane, di-i-propyldimethoxysilane, di-i-propyldiethoxysilane, di-n-butyldimethoxysilane, di-n-butyldiethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane, diphenyldiethoxysilane, and heptadecafluorodecylmethyldimethoxysilane,; methyltriacetyloxysilane; dimethyldiacetyloxysilane, and the like, as well as mixtures thereof.

Examples of alkylsilanes are CH₃(CH₂)5Si(OCH₃)₃(n-hexyltrimethoxysilane), CH₃(CH₂)₁₁Si(OC₂H₅)₃(n-dodecyltriethoxysilane), (CH₃)₂CHCH₂Si(OCH₃)₃(isobutyltrimethoxysilane), CH₃(CH₂)₅SiCl₃, CH₃(CH₂)₇SiCl₃, and (CH₃)₂CHCH₂SiCl₃. Suitable siloxanes include but are not limited to: 1,1,3,3,5,5-hexamethylsiloxane, octakis(dimethylsiloxy)-T8-silsesquioxane, pentamethylcyclopentasiloxane, heptamethyltrisiloxane, phenylhydrocyclosiloxane, phenyltris(dimethylsiloxy)silane, 1,1,2,2-tetraisopropyldisiloxane, tetrakis(dimethylsiloxy)silane, 1,3,5,7-tetremethyl-cyclo-tetrasiloxane, 1,1,3,3-tetramethyldisiloxane, tris(trimethylsiloxy)silane, methylhydrosiloxane-dimethylsiloxane copolymers, polymethylhydrosiloxane, poly(diethoxysiloxane), poly(dimethoxysiloxane) and the like.

Preferable silanes/siloxanes for use in the present invention include but are not limited to: 3-methacryloxypropyl-trimethoxysilane (for example DYNASILAN MEMO), 3-glycidyloxypropyltrimethoxysilane (for example DYNASILAN GLYMO), 3-methacryloyloxypropyltriethoxysilane, 3-methacryloyloxypropylmethyl-dimethoxysilane, 3-methacryloyloxypropylmethyldiethoxysilane, 3-methacryloyloxy-2-methylpropyltrimethoxysilane, 3-methacryloyloxy-2-methylpropyltriethoxysilane, vinyltrimethoxysilane, vinyltriethoxysilane, vinylmethyldimethoxysilane, vinylmethyldiethoxysilane, polymethylhydrosiloxane, poly(diethoxysiloxane), and poly(dimethoxysiloxane).

The sizing or primer compositions of the present invention preferably contain a mixture of a coupling agent and fluorine in a suitable carrier, preferably water. The sizing composition contains a solution containing the coupling agent, namely the organosilane or the organosiloxane or mixtures thereof in an amount within the range of from about 0.5 to about 20 weight percent, preferably in an amount within the range of from about 2 to about 5 weight percent; the fluorine in an amount within the range of from about 0.1 to about 5 weight percent, preferably in an amount within the range of from about 0.5 to about 2 weight percent.

The sizing or primer compositions of the present invention may additionally contain from about 0.1 to about 5 weight percent, preferably in an amount within the range of from about 0.5 to about 2 weight percent of alkali metal silicates such as sodium silicate or potassium silicate to further enhance the sizing properties of the process of the present invention.

The sizing or primer composition coating material is applied to the substrate such as a vitreous or polyolefin surface in the following manner. The surface is primed with sizing composition by applying a thin uniform coating to the entire surface or, if desirable, over a portion of the surface to be subsequently decorated. The primer can be wiped, squeegeed or applied with other thin coating application methods including spraying, vapor, brushing, dipping, cascading or mopping. The solvent is allowed to evaporate (flash-off), leaving a very light coating of the sizing composition thereby creating reactive sites for the subsequent coating, such as a radiation curable decorative coating on the substrate surface. In the case of silane, there is a well documented relationship of improved moisture and humidity resistance of silane prepared glass when used with coatings and adhesions over long periods of time. However it has been determined herein that the adhesion performance is further improved by the addition of the fluorine and further improved by the addition of an alkali metal silicate to the sizing or primer composition.

The glass substrate may be an inorganic or resin glass. The shape and the size of the glass substrate is not particularly limited. For example, the glass substrate may be a curved glass plate, a tempered glass plate, a single glass plate, a multiple glass plate, a laminated glass plate or a formed glass article such as a bottle, jar, pitcher or the like.

The sizing compound can be applied at temperature ranging at 4 to 50° C., by spray, vapor, brush, dipping, cascading or mopping. When dry the product will provide a bond between the substrate and the coating or ink. The compound is primarily designed for to improve the adhesion of UV or EV coatings or inks. The compound is formulated in such a manner as to form a bond with the substrates once coatings or inks are applied and will not wash off.

In addition to the foregoing chemical compounds, the treating composition of the present invention may include lubricants, antioxidants, bactericides and the like. The addition of these compounds to the composition does not serve any additional function or contribute any additional benefit for the composition.

Also present in the treating composition of the present invention is a liquid carrier, which is preferably water to make the treating composition an aqueous treating composition. The amount of water present in the aqueous treating composition is that amount necessary to give the treating composition a total solids content within a level, whereby the viscosity of the aqueous treating composition is effective for application to glass filaments, that is, a composition with a viscosity of around 0.6 to about 150 centipoise at 60° C. or less, although higher viscosities are possible with proper pumping equipment. Particularly, the amount of water present in the aqueous treating composition is sufficient to give a total solids (nonaqueous) content of the aqueous treating composition in the range of about 1 to about 25 percent by weight and preferably about 2 to about 10 percent by weight of the aqueous treating composition.

The treating composition of the present invention can be prepared by any method and with any equipment known to those skilled in the art for preparing aqueous treating compositions to be applied to glass, ceramic or polyolefin surfaces or fibers. For instance, the chemical compounds can be added sequentially or simultaneously to water or in any order whatsoever.

### The Decorating Method

The term “ceramic” or “vitreous article” when used in accordance with the invention shall mean glass, ceramic, tile, and similar vitreous materials. The articles which may be decorated or printed according to the method of the invention may be in any shape or form, such as a container, sheet, tile, figurine, or the like. In the preferred embodiment of the invention the article is made of glass or ceramic and is a container, such as a cosmetic or beverage container. The process of the present invention is also applicable to the coating of polyolefin surfaces, particularly polyethylene, or substituted polyolefins such as polyethylene terephthalate.

The ink composition is applied to the article to be decorated in a predetermined design using a variety of printing methods including screen printing, offset printing, gravure, hand painting and the like. After the ink is applied the substrate or article is irradiated with UV or actinic radiation using a conventional UV light source. The term “UV” means ultraviolet light which generally has a wavelength of 4 to 400, preferably 325 to 400 nanometers. The term “actinic” means radiation having a wavelength of 200 to 600 nanometers. Electron beam may be used instead of a UV light source. If a UV conveyer is used, it is set up so that the substrate passes through the beam of radiation for an amount of time appropriate to completely cure the ink composition and cause it to adhere to the substrate. If desired, the substrate may be moved through the conveyer in one or more passes to achieve the required curing. The appropriate time varies depending on the ink formula, but generally curing is complete in a period of time ranging from fractions of a second to 30 minutes. It is preferred, that by the time the decorated substrate or article is removed from the conveyer, the ink is completely cured and fused to the substrate surface. In some cases it may be necessary to subject the newly screened glass container to slightly elevated temperature prior to UV curing the applied ink on the substrate, or to an additional post-UV cure application of heat to finally polymerize the ink on the substrate. Preferably, the decorated substrate is subjected to post-UV cure heating at a temperature of 90 to 200° C., preferably 100-200° C. for a period of 0.5 to 30 minutes.

The ink compositions are well suited for use in automated systems such as the multiple color printing apparatus disclosed in U.S. Pat. No. 5,985,376 by Kamen, et al., entitled “Apparatus and Method For Screen Printing Radiation Curable Compostions”, or with the methods disclosed in U.S. Pat. No. 5,562,951, both of which are hereby incorporated by reference. Preferable radiation curable coatings are disclosed in U.S. Pat. No. 6,541,537 by Catena, entitled Acrylate Polymeric Compositions and Methods which is hereby incorporated by reference.

In another embodiment of the invention, it is possible to make the ink composition of the invention without the pigment and print it on the glass substrate after the application of the sizing layer in predetermined design according to the methods described above. For example, a substrate such as a container may be decorated in a pre-determined design by silk screening the unpigmented ink composition on the substrate and curing with the appropriate radiation. A layer of hot stamping foil is then compressed against the substrate with a press which is heated to a temperature sufficient to cause the hot stamping foil to adhere to the printed ink design but not to the ink-free areas of the glass. Hot stamping foil is generally a laminate comprised of a carrier material (often polyester or a similar material capable of release), a release film between the carrier and a subsequent decorative coat which is usually color or a metallized coat, most often aluminum or colored aluminum. The foil may contain other optional layers such as one or more protective layers, hot melt adhesive layers, etc. between the metallized layer or layers and the carrier material. More specifically, hot stamping foil can be defined as a multilayer web comprised of a backing film carrier, a release coating, one or more protective top coatings, one or more color coatings, and a hot melt adhesive in that order. The hot stamping foil is then compressed against the container with the hot melt adhesive layer being compressed against the substrate. The compress, which may be a standard hot stamping press or a hand held press, is heated to a temperature sufficient to cause the hot melt adhesive layer of the hot stamping foil to adhere to the ink decorated portion of the substrate. Generally this temperature ranges from about 250 to 400° F. Temperatures higher than this may cause deterioration of the hot stamping foil. The application of heat causes the adhesive side of the hot stamping foil to become adhesively adhered to the ink design but not to the ink-free areas of the substrate. When the compress is removed, a portion of the foil laminate adheres to the ink decoration but not to the ink free areas of the glass. In particular, adhered to the ink design on the substrate is the hot melt adhesive layer, the color coatings, and the protective top coatings, in that order, of the hot stamping foil. Portions of the release coating may or may not be adhered to the protective top coating because the release coating is designed to melt upon application of heat and cause the polyester carrier backing layer to release from the protective top coat layer and some remnants may remain. The resulting hot stamped substrate exhibits a metallic gold, silver, or colored appearance depending on the color of the hot stamping foil.

In yet another embodiment of the invention, it is possible to provide a decorated substrate which has a two tone effect where all or a portion of the colored ink on the substrate is hot stamped. In this instance a pigmented ink composition is applied to the sized substrate in a predetermined design and cured by exposing it to the radiation by which it is curable for a time sufficient to affect complete cure. Hot stamping foil is applied as described above to either the entire ink design or to only a part (i.e. complete or partial registration). If the hot stamping foil is applied in partial registration, or applied to a portion of the pigmented ink design, a pleasant two tone effect is achieved. Many times it is more economical to print the entire design on the sized substrate using colored ink and then hot stamp over the desired portion of the design, rather than applying clear ink and hot stamping, and then printing colored ink in the desired design in a second application.

The present invention is also suitable for substrates other than glass, for example, plastic and ceramic, which may include other types of containers such as cups, dishes, vases and other decorative glassware; and other cylindrical shaped articles to which there is a desire to provide a printed layer for decorative or functional purposes.

The composite decorative coating and sizing compositions of the invention display superior adhesion to glass or polyolefins such as polyethylene terephthalate (PET) or polyethylene nitrile (PEN), as well as exhibiting sufficient resistance to scuffing and scratching, to make the decorated articles suitable for use on commercial beverage and cosmetic bottles and the like.

The ink compositions as displayed in the prior art can be removed from glass upon exposure of the glass to alkali. In particular, inks containing free acid groups found in the polymerized ink composition are capable of reacting with the hydroxyl groups of the base to form a salt which is easily stripped or removed from the glass.

The aqueous alkaline solution comprises about 1-20%, preferably about 2-15%, more preferably about 2-12% by weight alkali. Suitable alkali materials include metal hydroxides (e.g. alkali metal and alkaline earth metal hydroxides) such as sodium hydroxide, potassium hydroxide, calcium hydroxide, and the like.

The cured ink compositions should be removed from the glass upon exposure to the aqueous alkali after a period of about 1 to 120, preferably about 1-60, more preferably about 1-30 minutes. The glass substrate is generally immersed in the aqueous alkali solution for the appropriate time period, after which the ink compositions are removed from the glass surface.

Preferably the glass container is subjected to the aqueous alkaline solution at a temperature of 60 to 100° C., more preferably 70 to 95° C., most preferably 72 to 90° C.

In the most preferred embodiment of the invention the ink composition is removed from the glass containers after exposure of the glass to a 4% (approximately) aqueous solution of sodium hydroxide at a temperature of 70 to 100° C., after 1-15 minutes.

The decorating method and compositions of the invention are excellent for use on glass, ceramic and polyolefin (PET) containers used in the returnable or disposable beverage market. The decorative indicia applied according to the invention remains on the glass for the useful commercial life of the container, yet can be easily removed upon exposure to an aqueous alkali solution. This process eliminates the need for paper labels and decals, resulting in a significant cost savings and produces indicia that are aesthetically pleasing. Thus, beverage and cosmetic manufacturers are able to offer glass containers that produce superior aesthetics, with indicia that can be easily removed upon exposure to alkali solutions when the glass container is returned to the filler.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims. Obviously, additional modifications and variations of the present invention are possible in light of the above teachings. It is therefore to be understood that within the scope of the appended claims, the invention may be practiced otherwise than as specifically described herein.

What is claimed is:

1. A process for preparing a vitreous or glass surface for adhesion to a polymer film or ink comprising: depositing a sizing compound comprising an aqueous mixture of a coupling agent and fluorine on the vitreous or glass surface to form a sizing layer.

2. The process according to claim 1, wherein said coupling agent is selected from the group consisting of an organosilane and an organosiloxane and mixtures thereof.

3. The process according to claim 1, wherein said coupling agent is selected from the group consisting of: tetra-alkoxysilanes including tetramethoxysilane, tetraethoxysilane, tetra-n-propoxysilane, tetra-i-propoxysilane, and tetra-n-butoxysilane; trialkoxysilane including methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, n-butyltrimethoxysilane, n-butyltriethoxysilane, n-pentyltrimethoxysilane, n-hexyltrimethoxysilane, n-heptyltrimethoxysilane, n-octyltrimethoxysilane, vinyltrimethoxysilane, vinyltriethoxysilane, cyclohexyltrimethoxysilane, cyclohexyltriethoxysilane, phenyltrimethoxysilane, phenyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyl-trimethoxysilane, 3-aminopropyltriethoxysilane, 2-hydroxyethyl-trimethoxysilane, 2-hydroxyethyl-triethoxysilane, 2-hydroxypropyltrimethoxysilane, 2-hydroxypropyltriethoxysilane, 3-hydroxypropyl-trimethoxysilane, 3-hydroxypropyltriethoxysilane, 3-mercaptopropyltrimethoxysilane, 3-mercaptopropyl-tri ethoxysilane, 3-isocianatopropyltrimethoxysilane, 3-isocianatopropyltriethoxysilane, 3-glycidoxypropyl-trimethoxysilane, 3-glycidoxypropyltriethoxysilane, 2-(3,4-epoxycyclohexyl)ethyltrimethoxysilane, 2-(3,4-epoxycyclohexyl) ethyltriethoxysilane, 3-(meth)-acryloxypropyltrimethoxysilane, 3-(meth)acryloxypropyl-triethoxysilane, 3-ureidopropyltrimethoxysilane, 3-ureidopropyltriethoxysilane, nonafluorohexyl-trimethoxysilane, heptadecafluorodecyltrimethoxysilane, and tridecafluoroctyltrimethoxysilane; dialkoxysilanes including dimethyldimethoxysilane, dimethyldiethoxysilane, diethyldimethoxysilane, diethyldiethoxysilane, di-n-propyldimethoxysilane, di-n-propyldiethoxysilane, di-i-propyldimethoxysilane, di-i-propyldiethoxysilane, di-n-butyldimethoxysilane, di-n-butyldiethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane, diphenyldiethoxysilane, and heptadecafluorodecylmethyldimethoxysilane; methyltriacetyloxysilane; dimethyldiacetyloxysilane, CH₃(CH₂)5Si(OCH₃)₃(n-hexyltrimethoxysilane), CH₃(CH₁₁Si(OC₂H₅)₃(n-dodecyltriethoxysilane), (CH₃)₂CHCH₂Si(OCH₃)₃(isobutyltrimethoxysilane), CH₃(CH₂)₅SiCl₃, CH₃(CH₂)₇SiCl₃, and (CH₃)₂CHCH₂SiCl₃, 1,1,3,3,5,5-hexamethylsiloxane, octakis(dimethylsiloxy)-T8-silsesquioxane, pentamethylcyclopentasiloxane, heptamethyltrisiloxane, phenylhydrocyclosiloxane, phenyltris(dimethylsiloxy)silane, 1,1,2,2-tetraisopropyldisiloxane, tetrakis(dimethylsiloxy)silane, 1,3,5,7-tetremethyl-cyclo-tetrasiloxane, 1,1,3,3-tetramethyldisiloxane, tris(trimethylsiloxy)silane, methylhydrosiloxane-dimethylsiloxane copolymers, polymethylhydrosiloxane, poly(diethoxysiloxane), poly(dimethoxysiloxane) and mixtures thereof.

4. The process according to claim 1, wherein the deposition of the sizing compound is performed by spraying of a solution of the sizing compound onto the vitreous or glass surface.

5. The process of claim 1 wherein the sizing compound additionally contains 0.1 to 5 percent by weight of an alkali metal silicate.

6. A method for applying decorative indicia to the surface of a vitreous or glass article comprising the steps of:
(a) applying to the surface of the article a primer composition comprising an aqueous solvent, a coupling agent and fluorine,
(b) after the primer composition is substantially dry, applying a radiation curable composition over the primer composition in a desired design, and
(c) curing the radiation curable composition with radiation, thereby causing the coupling agent to form a chemical bond between both the surface of the article and the cured ink composition.

7. The method of claim 6 wherein the primer composition comprises, by weight of the total composition: 0.1 to about 5 weight percent of fluorine; the coupling agent comprising: 0.5 to about 20 weight percent.

8. The method of claim 6 wherein the coupling agent comprises at least one compound selected from the group consisting of: tetra-alkoxysilanes including tetramethoxysilane, tetraethoxysilane, tetra-n-propoxysilane, tetra-i-propoxysilane, and tetra-n-butoxysilane; trialkoxysilane including methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, n-butyltrimethoxysilane, n-butyltriethoxysilane, n-pentyltrimethoxysilane, n-hexyltrimethoxysilane, n-heptyltrimethoxysilane, n-octyltrimethoxysilane, vinyltrimethoxysilane, vinyltriethoxysilane, cyclohexyltrimethoxysilane, cyclohexyltriethoxysilane, phenyltrimethoxysilane, phenyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyl-trimethoxysilane, 3-aminopropyltriethoxysilane, 2-hydroxyethyl-trimethoxysilane, 2-hydroxyethyl-triethoxysilane, 2-hydroxypropyltrimethoxysilane, 2-hydroxypropyltriethoxysilane, 3-hydroxypropyl-trimethoxysilane, 3-hydroxypropyltriethoxysilane, 3-mercaptopropyltrimethoxysilane, 3-mercaptopropyl-triethoxysilane, 3-isocianatopropyltrimethoxysilane, 3-isocianatopropyltriethoxysilane, 3-glycidoxypropyl-trimethoxysilane, 3-glycidoxypropyltriethoxysilane, 2-(3,4-epoxycyclohexyl)ethyltrimethoxysilane, 2-(3,4-epoxycyclohexyl) ethyltriethoxysilane, 3-(meth)-acryloxypropyltrimethoxysilane, 3-(meth)acryloxypropyl-triethoxysilane, 3-ureidopropyltrimethoxysilane, 3-ureidopropyltriethoxysilane, nonafluorohexyl-trimethoxysilane, heptadecafluorodecyltrimethoxysilane, and tridecafluoroctyltrimethoxysilane; dialkoxysilanes including dimethyldimethoxysilane, dimethyldiethoxysilane, diethyldimethoxysilane, diethyldiethoxysilane, di-n-propyldimethoxysilane, di-n-propyldiethoxysilane, di-i-propyldimethoxysilane, di-i-propyldiethoxysilane, di-n-butyldimethoxysilane, di-n-butyldiethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane, diphenyldiethoxysilane, and heptadecafluorodecylmethyldimethoxysilane; methyltriacetyloxysilane; dimethyldiacetyloxysilane, CH₃(CH₂)5Si(OCH₃)₃(n-hexyltrimethoxysilane), CH₃(CH₂)₁₁Si(OC₂H₅)₃(n-dodecyltriethoxysilane), (CH₃)₂CHCH₂Si(OCH₃)₃(isobutyltrimethoxysilane), CH₃(CH₂)₅SiCl₃, CH₃(CH₂)₇SiCl₃, and (CH₃)₂CHCH₂SiCl₃, 1,1,3,3,5,5-hexamethylsiloxane, octakis(dimethylsiloxy)-T8-silsesquioxane, pentamethylcyclopentasiloxane, heptamethyltrisiloxane, phenylhydrocyclosiloxane, phenyltris(dimethylsiloxy)silane, 1,1,2,2-tetraisopropyldisiloxane, tetrakis(dimethylsiloxy)silane, 1,3,5,7-tetremethyl-cyclo-tetrasiloxane, 1,1,3,3-tetramethyldisiloxane, tris(trimethylsiloxy)silane, methylhydrosiloxane-dimethylsiloxane copolymers, polymethylhydrosiloxane, poly(diethoxysiloxane), poly(dimethoxysiloxane) and mixtures thereof.

9. The method of claim 6 wherein the primer composition additionally contains 0.1 to 5 percent by weight of an alkali metal silicate.

10. The method of claim 6 wherein the primer composition is applied by spraying, vapor, brushing, dipping, cascading or mopping.

11. The method of claim 6 wherein the radiation curable composition is curable by ultraviolet radiation.

12. The method of claim 11 wherein the radiation curable composition is selected from the group consisting of: inks, monomers, oligomers or low molecular weight hompolymers, copolymers, terpolymers, graft copolymers, and block copolymers.

13. A method for applying decorative indicia to the surface of a vitreous or glass article comprising the steps of:
(a) applying to the surface of the article a primer composition comprising an aqueous solvent, a coupling agent and fluorine,
(b) after the primer composition is substantially dry, applying a radiation curable composition over the primer composition in a desired design, and
(c) curing the radiation curable composition with radiation, thereby causing the coupling agent to form a chemical bond between both the surface of the article and the cured ink composition.

14. The method of claim 13 wherein the primer composition comprises, by weight of the total composition: 0.1 to about 5 weight percent of fluorine; the coupling agent comprising: 0.5 to about 20 weight percent.

15. The method of claim 13 wherein the coupling agent comprises at least one compound selected from the group consisting of: tetra-alkoxysilanes including tetramethoxysilane, tetraethoxysilane, tetra-n-propoxysilane, tetra-i-propoxysilane, and tetra-n-butoxysilane; trialkoxysilane including methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, n-butyltrimethoxysilane, n-butyltriethoxysilane, n-pentyltrimethoxysilane, n-hexyltrimethoxysilane, n-heptyltrimethoxysilane, n-octyltrimethoxysilane, vinyltrimethoxysilane, vinyltriethoxysilane, cyclohexyltrimethoxysilane, cyclohexyltriethoxysilane, phenyltrimethoxysilane, phenyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyl-trimethoxysilane, 3-aminopropyltriethoxysilane, 2-hydroxyethyl-trimethoxysilane, 2-hydroxyethyl-triethoxysilane, 2-hydroxypropyltrimethoxysilane, 2-hydroxypropyltriethoxysilane, 3-hydroxypropyl-trimethoxysilane, 3-hydroxypropyltriethoxysilane, 3-mercaptopropyltrimethoxysilane, 3-mercaptopropyl-triethoxysilane, 3-isocianatopropyltrimethoxysilane, 3-isocianatopropyltriethoxysilane, 3-glycidoxypropyl-trimethoxysilane, 3-glycidoxypropyltriethoxysilane, 2-(3,4-epoxycyclohexyl)ethyltrimethoxysilane, 2-(3,4-epoxycyclohexyl) ethyltriethoxysilane, 3-(meth)-acryloxypropyltrimethoxysilane, 3-(meth)acryloxypropyl-triethoxysilane, 3-ureidopropyltrimethoxysilane, 3-ureidopropyltriethoxysilane, nonafluorohexyl-trimethoxysilane, heptadecafluorodecyltrimethoxysilane, and tridecafluoroctyltrimethoxysilane; dialkoxysilanes including dimethyldimethoxysilane, dimethyldiethoxysilane, diethyldimethoxysilane, diethyldiethoxysilane, di-n-propyldimethoxysilane, di-n-propyldiethoxysilane, di-i-propyldimethoxysilane, di-i-propyldiethoxysilane, di-n-butyldimethoxysilane, di-n-butyldiethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane, diphenyldiethoxysilane, and heptadecafluorodecylmethyldimethoxysilane; methyltriacetyloxysilane; dimethyldiacetyloxysilane, CH₃(CH₂)5Si(OCH₃)₃(n-hexyltrimethoxysilane), CH₃(CH₂)₁₁Si(OC₂H₅)₃(n-dodecyltriethoxysilane), (CH₃)₂CHCH₂Si(OCH₃)₃(isobutyltrimethoxysilane), CH₃(CH₂)₅SiCl₃, CH₃(CH₂)₇SiCl₃, and (CH₃)₂CHCH₂SiCl₃, 1,1,3,3,5,5-hexamethylsiloxane, octakis(dimethylsiloxy)-T8-silsesquioxane, pentamethylcyclopentasiloxane, heptamethyltrisiloxane, phenylhydrocyclosiloxane, phenyltris(dimethylsiloxy)silane, 1,1,2,2-tetraisopropyldisiloxane, tetrakis(dimethylsiloxy)silane, 1,3,5,7-tetremethyl-cyclo-tetrasiloxane, 1,1,3,3-tetramethyldisiloxane, tris(trimethylsiloxy)silane, methylhydrosiloxane-dimethylsiloxane copolymers, polymethylhydrosiloxane, poly(diethoxysiloxane), poly(dimethoxysiloxane) and mixtures thereof.

16. The method of claim 13 wherein the primer composition additionally contains 0.1 to 5 percent by weight of an alkali metal silicate.

17. The method of claim 13 wherein the primer composition is applied by spraying, vapor, brushing, dipping, cascading or mopping.

18. The method of claim 13 wherein the radiation curable composition is curable by ultraviolet radiation.

19. The method of claim 13 wherein the radiation curable composition is selected from the group consisting of: inks, monomers, oligomers or low molecular weight hompolymers, copolymers, terpolymers, graft copolymers, and block copolymers.
